(19) United States
(12) Patent Application Publication
(10) Pub. No.: US 2015/0002772 A1
(43) Pub. Date: Jan. 1, 2015

(54) Liquid Crystal Display Panel

(71) Applicant: Shenzhen China Star Optoelectronics Technology Co., Ltd., Shenzhen,Guangdong (CN)

(72) Inventor: Peng Du, Shenzhen City (CN)

(21) Appl. No.: 13/985,287

(22) PCT Filed: Jul. 3, 2013
(86) PCT No.: PCT/CN2013/078717

§ 371 Date: Aug. 13, 2013

(30) Foreign Application Priority Data
Jun. 28, 2013 (CN) 2013102702983

(51) Int. Cl. G02F 1/1339

(52) U.S. Cl. CPC G02F 1/13394
USPC 349/43

(57) ABSTRACT

The present invention discloses a liquid crystal display panel. The liquid crystal display panel comprises at least one first spacer provided between first and second substrates. The bottom of the first spacer is connected with the first substrate, and the top thereof extends to the second substrate and is away from the second substrate. Wherein, the second substrate is provided with a blocking structure corresponding to the first spacer, which is used to cooperate with the corresponding first spacer to prevent the first substrate sliding opposite to the second substrate. The present invention can prevent the first substrate of the liquid crystal display panel sliding opposite to the second substrate.

### BACKGROUND OF THE INVENTION

1. Field of the Invention

The present invention relates to the field of display technology, and in particular to a liquid crystal display panel.

2. The Related Arts

Liquid crystal display panel is an important part of the liquid crystal display. With the gradual maturity of the liquid crystal display technology, large-size liquid crystal display panel also becomes more common.

The upper and lower substrates of the large-size liquid crystal display panel are prone to slide oppositely causing dislocation when being impacted during transportation, which will result in poor display effects of the liquid crystal display panel.

Therefore, it needs to provide a liquid crystal display to solve the above problems.

### SUMMARY OF THE INVENTION

The technical issue to be solved by the present invention is to provide a liquid crystal display, which can prevent the first substrate of the liquid crystal display panel sliding opposite to the second substrate.

In order to solve the above issue, a technical solution adopted by the present invention is to provide a liquid crystal display panel comprising: a first substrate and a second substrate provided oppositely, and at least one first spacer and a second spacer provided between the first substrate and the second substrate; the second substrate being provided with a gate line and a data line intersecting each other, multiple layers being provided on the gate line, the multiple layers comprising sequentially a gate insulating layer, a semiconductor active layer, an ohmic contact layer, a drain-source layer and a passivation layer, the first spacer being provided corresponding to the gate line, the bottom of the first spacer being connected with the first substrate, the top the first spacer extending to the second substrate and being away from the second substrate, the bottom of the second spacer being connected with the first substrate, the top of the second spacer being connected with the second substrate; wherein, the second substrate is provided with a blocking structure corresponding to the first spacer, the blocking structure is located between the two adjacent data lines and extends to the first substrate, the height of the blocking structure overlaps that of the first spacer in the height direction of the liquid crystal display panel, which is used to cooperate with the first spacer to prevent the first substrate sliding opposite to the second substrate, the blocking structure is a convex structure surrounding the first spacer, the blocking structure is formed by partially etching the multiple layers.

Wherein, the region of the first spacer corresponding to the second substrate is sequentially provided with the gate line and the gate insulating layer.

In order to solve the above issue, another technical solution adopted by the present invention is to provide a liquid crystal display panel, comprising: a first substrate and a second substrate provided oppositely, and at least one first spacer provided between the first substrate and the second substrate; the second substrate being provided with a gate line and a data line intersecting each other, the first spacer being provided corresponding to the gate line, the bottom of the first spacer being connected with the first substrate, the top the first spacer extending to the second substrate and being away from the second substrate; wherein, the second substrate is provided with a blocking structure corresponding to the first spacer, the blocking structure is located between the two adjacent data lines and extends to the first substrate, the height of the blocking structure overlaps that of the first spacer in the height direction of the liquid crystal display panel, which is used to cooperate with the first spacer to prevent the first substrate sliding opposite to the second substrate.

Wherein, the blocking structure is a convex structure surrounding the first spacer.

Wherein, the blocking structure is a convex structure provided at two opposite sides of the first spacer, or the blocking structure is a convex structure provided at one side of the first spacer.

Wherein, multiple layers is provided on the gate line, the blocking structure is formed by partially etching the multiple layers, the multiple layers comprises sequentially a gate insulating layer, a semiconductor active layer, an ohmic contact layer, a drain-source layer and a passivation layer.

Wherein, the liquid crystal display panel further comprises a second spacer provided between the first substrate and the second substrate, the bottom of the second spacer is connected with the first substrate, the top of the second spacer is connected with the second substrate.

Wherein, the region of the first spacer corresponding to the second substrate is sequentially provided with the gate line and the gate insulating layer.

Wherein, the region of the second spacer corresponding to the second substrate is sequentially provided with the gate line, the gate insulating layer, the semiconductor active layer, the ohmic contact layer and the drain-source layer, the top of the second spacer abuts on the drain-source layer.

Wherein, the region of the second spacer corresponding to the second substrate is sequentially provided with the gate line, the gate insulating layer, the drain-source layer and the passivation lay the top of the second spacer abuts on the passivation layer.

Wherein, the region of the second spacer corresponding to the second substrate is sequentially provided with the gate line, the gate insulating layer and the drain-source layer, the top of the second spacer abuts on the drain-source layer.

Wherein, the region of the first spacer corresponding to the second substrate is sequentially provided with the gate line, the gate insulating layer and the passivation layer.

Wherein, the region of the second spacer corresponding to the second substrate is sequentially provided with the gate line, the gate insulating layer, the semiconductor active layer, the ohmic contact layer and the drain-source layer, the top of the second spacer abuts on the drain-source layer.

Wherein, the region of the second spacer corresponding to the second substrate is sequentially provided with the gate line, the gate insulating layer, the drain-source layer and the passivation layer, the top of the second spacer abuts on the passivation layer.

Wherein, the region of the second spacer corresponding to the second substrate is sequentially provided with the gate line, the gate insulating layer and the drain-source layer, the top of the second spacer abuts on the drain-source layer.

The benefits of the present invention are as follows. Differing from the situation of the prior art, the present invention provides the blocking structure and the first spacer to cooperate with each other to prevent the first substrate sliding opposite to the second substrate. Moreover, by decreasing the layers below the second space, increase the height of the overlapping portion of the blocking structure and the first spacer, and then improve the cooperation of the blocking structure and the first spacer, which significantly prevents the first substrate sliding opposite to the second substrate.

### BRIEF DESCRIPTION OF THE DRAWINGS

FIG. 1 is a sectional view of the liquid crystal display panel according to the first embodiment of the present invention;

FIG. 2 is a top view of the liquid crystal display panel according to the first embodiment of the present invention;

FIG. 3 is a top view of the liquid crystal display panel according to the second embodiment of the present invention;

FIG. 4 is a top view of the liquid crystal display panel according to the third embodiment of the present invention;

FIG. 5 is a top view of the liquid crystal display panel according to the fourth embodiment of the present invention;

FIG. 6 is a sectional view of the liquid crystal display panel according to the fifth embodiment of the present invention;

FIG. 7 is a sectional view of the liquid crystal display panel according to the sixth embodiment of the present invention;

FIG. 8 is a sectional view of the liquid crystal display panel according to the seventh embodiment of the present invention; and

FIG. 9 is a sectional view of the liquid crystal display panel according to the eighth embodiment of the present invention;

### DETAILED DESCRIPTION OF THE PREFERRED EMBODIMENTS

The detailed descriptions accompanying drawings and the embodiment of the present invention are as follows.

Referring to FIG. 1, FIG. 1 is a sectional view of the liquid crystal display panel according to the first embodiment of the present invention. In the present invention, the liquid crystal display panel comprises a first substrate 10 and a second substrate 11 provided oppositely, and a first spacer 12 and a second spacer 16 provided between the first substrate 10 and the second substrate 11. The bottom of the first spacer 12 is connected with the first substrate 10, and the top the first spacer 12 extends to the second substrate 11 and is away from the second substrate 11. The bottom of the second spacer 16 is connected with the first substrate 10, and the top of the second spacer 16 is connected with the second substrate 11. Wherein, the second substrate 11 is provided with a blocking structure 13 corresponding to the first spacer 12. The blocking structure 13 extends to the first substrate 10. The height of the blocking structure 13 overlaps that of the first spacer 12 in the height direction of the liquid crystal display panel. The overlapping height as shown in FIG. 1 is h. The blocking structure 13 is used to cooperate with the first spacer 12 to prevent the first substrate 10 sliding opposite to the second substrate 11.

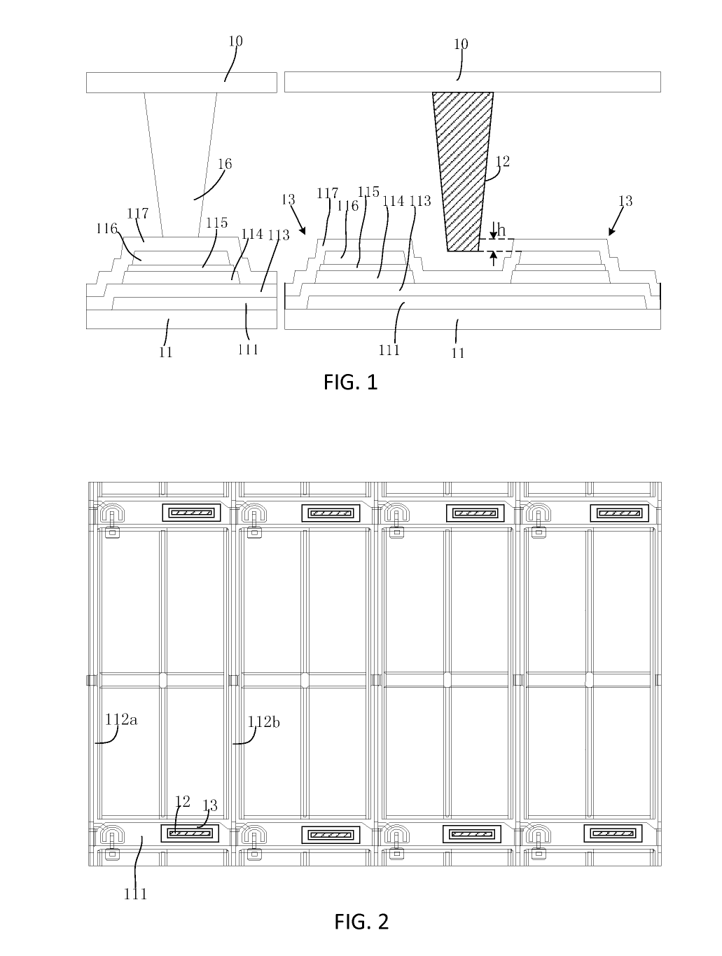

FIG. 2 is a top view of the liquid crystal display panel according to the first embodiment of the present invention. In order to describe conveniently, the top view mainly shows the portion of the first spacer 12. Referring to FIG. 2, the second substrate 11 is provided with a gate line 111 and data lines 112a, 112b intersecting each other. The first spacer 12 is provided corresponding to the gate line 111. The blocking structure 13 is located between the two adjacent data lines 112a, 112b.

In the present invention, the blocking structure 13 is a convex structure 13 surrounding the first spacer 12. The blocking structure 13 is used to prevent the first substrate 10 sliding opposite to the second substrate 11 in any direction on the plane of the first substrate 10. The height of the blocking structure 13 overlaps that of the first spacer 12 in the height direction of the liquid crystal display panel, so the blocking structure 13 can block the first spacer 12 and prevent the first substrate 10 sliding opposite to the second substrate 11. Moreover, the blocking structure 13 surrounds the first spacer 12, so the blocking structure 13 can prevent the first substrate 10 sliding opposite to the second substrate 11 in any direction on the plane of the first substrate 10.

Referring to FIG. 1 again, in the present embodiment, multiple layers 13 is provided on the gate line 111. The blocking structure 13 is formed by partially etching the multiple layers 13. The multiple layers comprise sequentially a gate insulating layer 113, a semiconductor active layer 114, an ohmic contact layer 115, a drain-source layer 116 and a passivation layer 117. The region of the first spacer 12 corresponding to the second substrate is sequentially provided with the gate line 111, the gate insulating layer 113 and the passivation layer 117. The region of the second spacer 16 corresponding to the second substrate is sequentially provided with the gate line 111, the gate insulating layer 113, the semiconductor active layer 114, the ohmic contact layer 115, the drain-source layer 116 and the passivation layer 117. The top of the second spacer 16 abuts on the passivation layer 117.

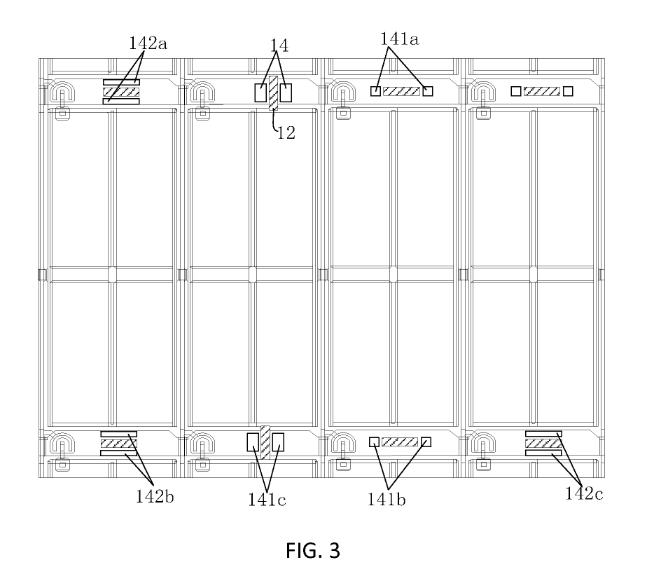

Referring to FIG. 3, FIG. 3 is a top view of the liquid crystal display panel according to the second embodiment of the present invention. Comparing with the liquid crystal display panel according to the first embodiment of the present invention, the blocking structure 14 according to the present embodiment is a convex structure 14 provided at two opposite sides of the first spacer 12. Specifically, the first substrate 10 and the second substrate 11 are preferably rectangular. Multiple first blocking structures 141a, 141b, 141c used to prevent the first substrate 10 sliding opposite to the second substrate 11 in the long-side direction of the first substrate 10 and multiple second blocking structures 142a, 142b, 142c used to prevent the first substrate 10 sliding opposite to the second substrate 11 in the short-side direction of the first substrate 10 are preferably provided on the second substrate 11. In the present embodiment, the number of the multiple first blocking structures 141a, 141b, 141c is preferably larger than that of the multiple second blocking structures 142a, 142b, 142c. For example, in the liquid crystal display panel according to the present embodiment, the number ratio of the first blocking structures to the second blocking structures is 3:1. In the other embodiments, the number of the multiple first blocking structures 141a, 141b. 141c can be less than or equal to that of the multiple second blocking structures 142a, 142b, 142c, which is not limited in the present invention.

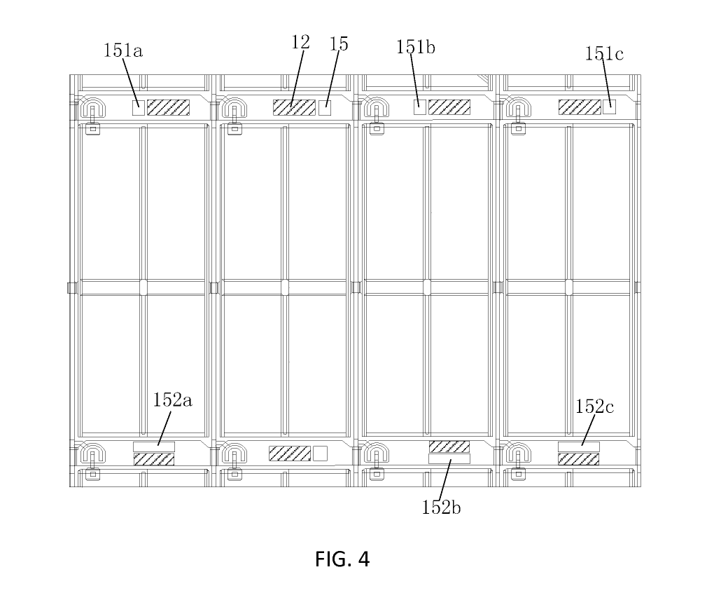

Referring to FIG. 4, FIG. 4 is a top view of the liquid crystal display panel according to the third embodiment of the present invention. Comparing with the liquid crystal display panel according to the first embodiment and the second embodiment of the present invention, the blocking structure 15 according to the present embodiment is a convex structure 15 provided at one side of the first spacer 12. Multiple first blocking structures 151a, 151b, 151c used to prevent the first substrate 10 sliding opposite to the second substrate 11 in the long-side direction of the first substrate 10 and multiple second blocking structures 152a, 152b, 152c used to prevent the first substrate 10 sliding opposite to the second substrate 11 in the short-side direction of the first substrate 10 are preferably provided on the second substrate 11. In the present embodiment, the number of the multiple first blocking structures 151a, 151b. 151c is preferably larger than that of the multiple second blocking structures 152a, 152b, 152c. For example, in the liquid crystal display panel according to the present embodiment, the number ratio of the first blocking structures to the second blocking structures is 3:1. In the other embodiments, the number of the multiple first blocking structures 151a, 151b, 151c can be less than or equal to that of the multiple second blocking structures 152a, 152b, 152c, which is not limited in the present invention.

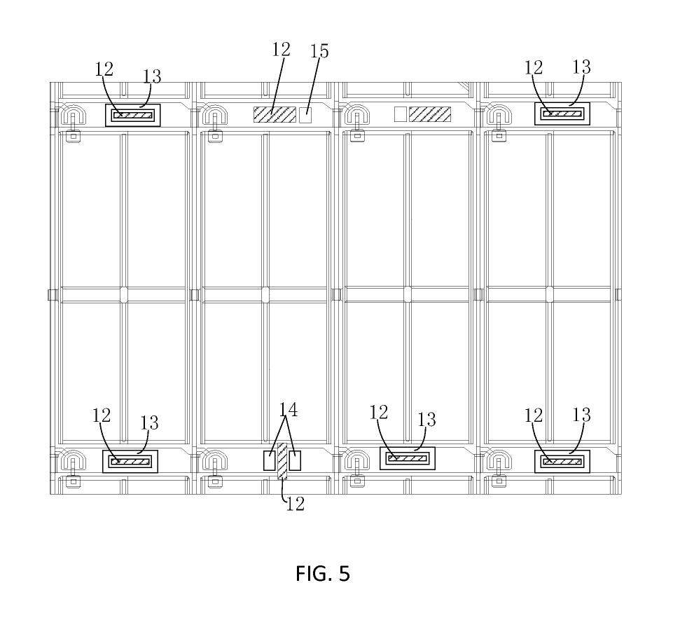

Referring to FIG. 5, FIG. 5 is a top view of the liquid crystal display panel according to the fourth embodiment of the present invention. In the present embodiment, the liquid crystal display panel comprises the blocking structure 13 according to the first embodiment, the blocking structure 14 according to the second embodiment and the blocking structure 15 according to the third embodiment at the same time. It should be understood that the liquid crystal display panel according to the other embodiment can only comprises any two among three.

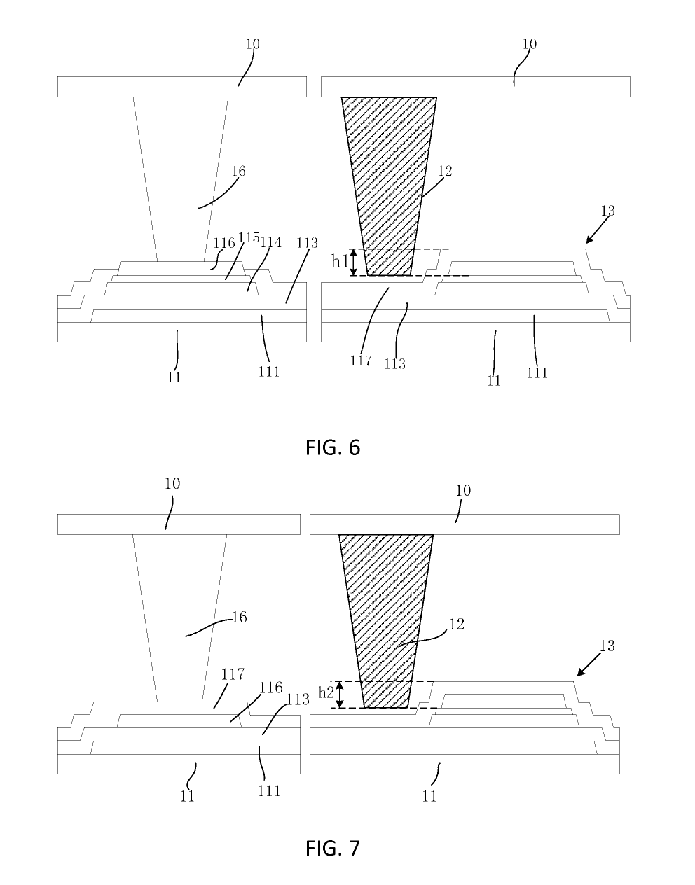

Referring to FIG. 6, FIG. 6 is a sectional view of the liquid crystal display panel according to the fifth embodiment of the present invention. Comparing with the liquid crystal display panel according to the first embodiment of the present invention, in the present embodiment, the region of the second spacer 16 corresponding to the second substrate is sequentially provided with the gate line 111, the gate insulating layer 113, the semiconductor active layer 114, the ohmic contact layer 115 and the drain-source layer 116. The top of the second spacer 16 abuts on the drain-source layer 116. Comparing with the first embodiment of the present invention, the present embodiment makes the overlapping height hi of the blocking structure 13 and the first spacer 12 in the height direction of the liquid crystal display panel larger (h1>h), so that the blocking is more reliable.

Referring to FIG. 7, FIG. 7 is a sectional view of the liquid crystal display panel according to the sixth embodiment of the present invention. Comparing with the fifth embodiment of the present invention, in the present embodiment, the region of the second spacer 16 corresponding to the second substrate is sequentially provided with the gate line 111, the gate insulating layer 113, the drain-source layer 116 and the passivation layer 117. The top of the second spacer 16 abuts on the passivation layer 117. Comparing with the fifth embodiment of the present invention, the present embodiment makes the overlapping height h2 of the blocking structure 13 and the first spacer 12 in the height direction of the liquid crystal display panel larger (h2>h), so that the blocking is more reliable.

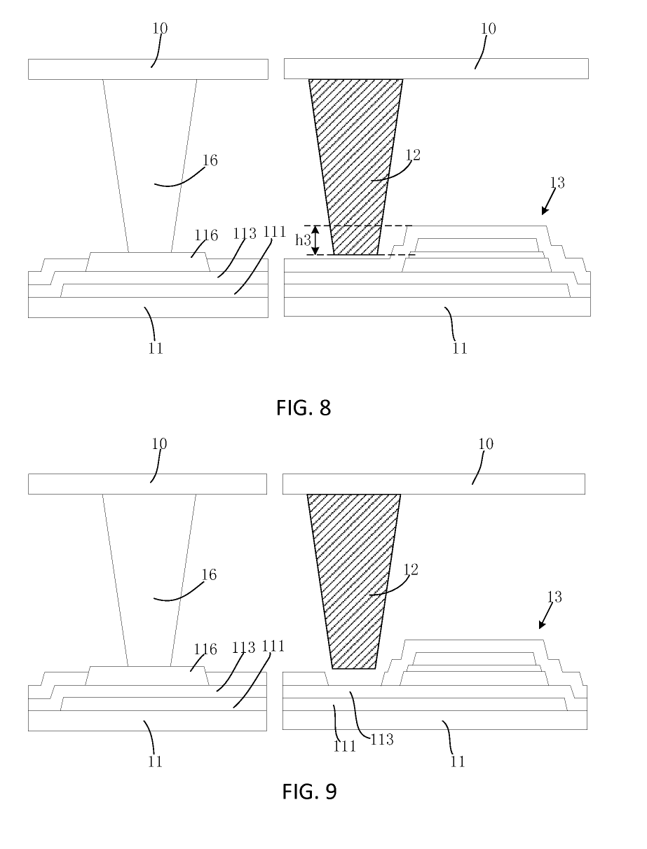

Referring to FIG. 8, FIG. 8 is a sectional view of the liquid crystal display panel according to the seventh embodiment of the present invention. Comparing with the sixth embodiment of the present invention, in the present embodiment, the region of the second spacer 16 corresponding to the second substrate is sequentially provided with the gate line 111, the gate insulating layer 113 and the drain-source layer 116. The top of the second spacer 16 abuts on the drain-source layer 116. Comparing with the sixth embodiment of the present invention, the present embodiment makes the overlapping height h3 of the blocking structure 13 and the first spacer 12 in the height direction of the liquid crystal display panel larger (h3>h), so that the blocking is more reliable.

Referring to FIG. 9, FIG. 9 is a sectional view of the liquid crystal display panel according to the eighth embodiment of the present invention. Comparing with the first, fifth, sixth, and seventh embodiments of the present invention, the region of the first spacer 12 corresponding to the second substrate is sequentially provided with the gate line 111 and the gate insulating layer 113. This way can prevent the first spacer 12 contacting the second substrate 11 when increasing the overlapping height of the blocking structure 13 and the first spacer 12 in the height direction of the liquid crystal display panel.

It should be understood that a new embodiment can be formed by combining the above embodiments, which is not repeated here.

The present invention provides the blocking structure and the first spacer to cooperate with each other to prevent the first substrate sliding opposite to the second substrate. Moreover, by decreasing the layers below the second space, increase the height of the overlapping portion of the blocking structure and the first spacer, and then improve the cooperation of the blocking structure and the first spacer, which significantly prevents the first substrate sliding opposite to the second substrate.

The preferred embodiments according to the present invention are mentioned above, which cannot be used to define the scope of the right of the present invention. Those modifications and variations are considered encompassed in the scope of protection defined by the dams of the present invention.

What is claimed is:

1. A liquid crystal display panel, wherein the liquid crystal display panel comprises: a first substrate and a second substrate provided oppositely, and at least one first spacer and a second spacer provided between the first substrate and the second substrate; the second substrate being provided with a gate line and a data line intersecting each other, multiple layers being provided on the gate line, the multiple layers comprising sequentially a gate insulating layer, a semiconductor active layer, an ohmic contact layer, a drain-source layer and a passivation layer, the first spacer being provided corresponding to the gate line, the bottom of the first spacer being connected with the first substrate, the top the first spacer extending to the second substrate and being away from the second substrate, the bottom of the second spacer being connected with the first substrate, the top of the second spacer being connected with the second substrate;
wherein, the second substrate is provided with a blocking structure corresponding to the first spacer, the blocking structure is located between the two adjacent data lines and extends to the first substrate, the height of the blocking structure overlaps that of the first spacer in the height direction of the liquid crystal display panel, which is used to cooperate with the first spacer to prevent the first substrate sliding opposite to the second substrate, the blocking structure is a convex structure surrounding the first spacer, the blocking structure is formed by partially etching the multiple layers.

2. The liquid crystal display panel as claimed in claim 1, wherein the region of the first spacer corresponding to the second substrate is sequentially provided with the gate line and the gate insulating layer.

3. A liquid crystal display panel, wherein the liquid crystal display panel comprises: a first substrate and a second substrate provided oppositely, and at least one first spacer provided between the first substrate and the second substrate; the second substrate being provided with a gate line and a data line intersecting each other, the first spacer being provided corresponding to the gate line, the bottom of the first spacer being connected with the first substrate, the top the first spacer extending to the second substrate and being away from the second substrate;
wherein, the second substrate is provided with a blocking structure corresponding to the first spacer, the blocking structure is located between the two adjacent data lines and extends to the first substrate, the height of the blocking structure overlaps that of the first spacer in the height direction of the liquid crystal display panel, which is used to cooperate with the first spacer to prevent the first substrate sliding opposite to the second substrate.

4. The liquid crystal display panel as claimed in claim 3, wherein the blocking structure is a convex structure surrounding the first spacer.

5. The liquid crystal display panel as claimed in claim 3, wherein the blocking structure is a convex structure provided at two opposite sides of the first spacer, or the blocking structure is a convex structure provided at one side of the first spacer.

6. The liquid crystal display panel as claimed in claim 3, wherein multiple layers is provided on the gate line, the blocking structure is formed by partially etching the multiple layers, the multiple layers comprises sequentially a gate insulating layer, a semiconductor active layer, an ohmic contact layer, a drain-source layer and a passivation layer.

7. The liquid crystal display panel as claimed in claim 6, wherein the liquid crystal display panel further comprises a second spacer provided between the first substrate and the second substrate, the bottom of the second spacer is connected with the first substrate, the top of the second spacer is connected with the second substrate

8. The liquid crystal display panel as claimed in claim 7, wherein the region of the first spacer corresponding to the second substrate is sequentially provided with the gate line and the gate insulating layer.

9. The liquid crystal display panel as claimed in claim 8 wherein the region of the second spacer corresponding to the second substrate is sequentially provided with the gate line, the gate insulating layer, the semiconductor active layer, the ohmic contact layer and the drain-source layer, the top of the second spacer abuts on the drain-source layer.

10. The liquid crystal display panel as claimed in claim 8, wherein the region of the second spacer corresponding to the second substrate is sequentially provided with the gate line, the gate insulating layer, the drain-source layer and the passivation layer, the top of the second spacer abuts on the passivation layer.

11. The liquid crystal display panel as claimed in claim 8, wherein the region of the second spacer corresponding to the second substrate is sequentially provided with the gate line, the gate insulating layer and the drain-source layer, the top of the second spacer abuts on the drain-source layer.

12. The liquid crystal display panel as claimed in claim 7, wherein the region of the first spacer corresponding to the second substrate is sequentially provided with the gate line, the gate insulating layer and the passivation layer.

13. The liquid crystal display panel as claimed in claim 12, wherein the region of the second spacer corresponding to the second substrate is sequentially provided with the gate line, the gate insulating layer, the semiconductor active layer, the ohmic contact layer and the drain-source layer, the top of the second spacer abuts on the drain-source layer.

14. The liquid crystal display panel as claimed in claim 12, wherein the region of the second spacer corresponding to the second substrate is sequentially provided with the gate line, the gate insulating layer, the drain-source layer and the passivation layer, the top of the second spacer abuts on the passivation layer.

15. The liquid crystal display panel as claimed in claim 12, wherein the region of the second spacer corresponding to the second substrate is sequentially provided with the gate line, the gate insulating layer and the drain-source layer, the top of the second spacer abuts on the drain-source layer.
